(19) United States
(12) Patent Application Publication
(10) Pub. No.: US 2009/0319624 A1
(43) Pub. Date: Dec. 24, 2009

(54) METHOD AND SYSTEM FOR THE OPTIMIZATION OF ELECTRONIC MAIL DELIVERY

(75) Inventors: Giovanni Buschi, Nice (FR); Beatrice Coulomb, Cagnes su Mer (FR); Dimitris Gibault, Cagnes sur Mer (FR); Christophe Palaysi, Villeneuve Loubet (FR)

Correspondence Address: Cantor Colburn LLP-IBM Europe, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/164,585

(22) Filed: Jun. 30, 2008

(30) Foreign Application Priority Data
Jun. 20, 2008 (FR) 080305289.4

(51) Int. Cl. G06F 15/16

(52) U.S. Cl. 709/206

(57) ABSTRACT

A method for the elimination of duplicate or multiple electronic mail (email) to one or more recipients, the method includes: generating table entries in a mail server that identify users of the mail server; receiving an email at the mail server; determining whether this is the first time the email is received at the mail server; wherein in the event this is the first time the email has been received: recording information about the email in the table; storing a copy of the email in a repository; forwarding the email to the intended recipients; and wherein in the event the email has been received previously: determining which of the intended recipients has not received the email; sending a copy of the email from the repository to the recipients who have not already received the email; and recording which of the recipients have now received the email in the table.

This application claims priority to European Patent Application No. 080305289.4, filed 20 Jun. 2008, and all the benefits accruing therefrom under 35 U.S.C. §119, the contents of which in its entirety are herein incorporated by reference.

### BACKGROUND OF THE INVENTION

1. Field of the Invention

This invention relates generally to computer software, and more particularly to a method and system for the elimination of the storing, sending, and receiving of duplicate electronic mail by originating senders and recipients.

2. Description of the Related Art

Electronic mail (email) has become a central feature of modern life and users have come to expect to receive electronic mail messages at any time and in virtually any place. For example, during the course of one day of travel, a user may receive electronic mail messages at a home desktop computer in the early morning, an office desktop computer in midmorning, via a cell phone or personal digital assistant in a taxi on the way to the airport, on a laptop computer via a wireless local area network while waiting in the airport lounge, via an in-flight telephone on the airplane, and in a hotel room via a high-speed Internet connection provided by the hotel at the end of the day.

The widespread proliferation and availability of electronic messaging has provided an efficient method to communicate information. In fact electronic messaging with its near instantaneous delivery from sender to receiver has made it the preferred method of personnel and business communication where hardcopy signatures are not required. In addition the ease of use and minimal cost of distribution has led to mass email to large distribution lists, as well as using email as a broad collaborative tool.

### SUMMARY OF THE INVENTION

Embodiments of the present invention include a method for the elimination of duplicate or multiple electronic mail (email) communications to one or more recipients, the method includes: generating table entries in a mail server that identify users of the mail server; receiving an email at the mail server; determining whether the receiving an email at the mail server represents the first time the email is received at the mail server, based on prior entries in the table generated for previous received emails; wherein, in the event it is determined that it is the first time the email has been received by the mail server: recording information about the email in the table; storing a copy of the email in a repository; forwarding the email to one or more intended recipients that are among the identified users of the mail server; and wherein in the event the email has been received previously by the mail server: determining which of the one or more intended recipients has not received the email, based on prior entries in the table generated for previous received emails; sending a copy of the email from the repository to one or more recipients who have not already received the email; and recording which of the one or more recipients have now received the email in the table.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, a solution is technically achieved for a method and a method and system for the elimination of the storing, sending, and receiving of duplicate electronic mail by originating senders and recipients.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a diagram that illustrates the generation of multiple duplicate newsletter emails from a single originating sender to several direct and indirect recipients.

FIG. 2A is a functional block diagram illustrating the flow of a message in a system where an originator forwards an email to recipients located on different servers, according to embodiments of the invention.

FIG. 2B is a functional block diagram of the system of FIG. 2A where a recipient forwards an email to various other recipients located on various severs, according to embodiments of the invention.

FIG. 3 is a flow diagram that illustrates a method for implementing embodiments of the invention.

FIG. 4 illustrates a system for implementing embodiments of the invention.

The detailed description explains the preferred embodiments of the invention, together with advantages and features, by way of example with reference to the drawings.

### DETAILED DESCRIPTION

The explosive growth in the use of email has led to the use of email as a collaborative, and information tool where many recipients are copied, and many recipients respond to the received electronic messages and associated content. However, the mechanisms that are presently available to send, receive and process email and content therein are not optimal for certain types of email, such as newsletters, skill development documents, highlights, and event announcements (marketing or other). The aforementioned email types are generally very large, contain images, and attachments, and therefore maybe several megabytes (MB) in size. In addition, the aforementioned email types tend to be non urgent, and have large distribution lists.

The aforementioned email types may only be sent once by the originator, however, the emails may then be forwarded by managers or focal contacts, who resend the email to a large distribution list without verifying whether one or several persons have already received it. As a consequence, the forwarded emails may be received by a large number of recipients several times, which causes increased traffic volume over an enterprise's network, and has a potentially adverse impact on the enterprise's systems involved in the mail traffic including: increased system storage utilization—memory and disk; and increased central processor unit (CPU) loading.

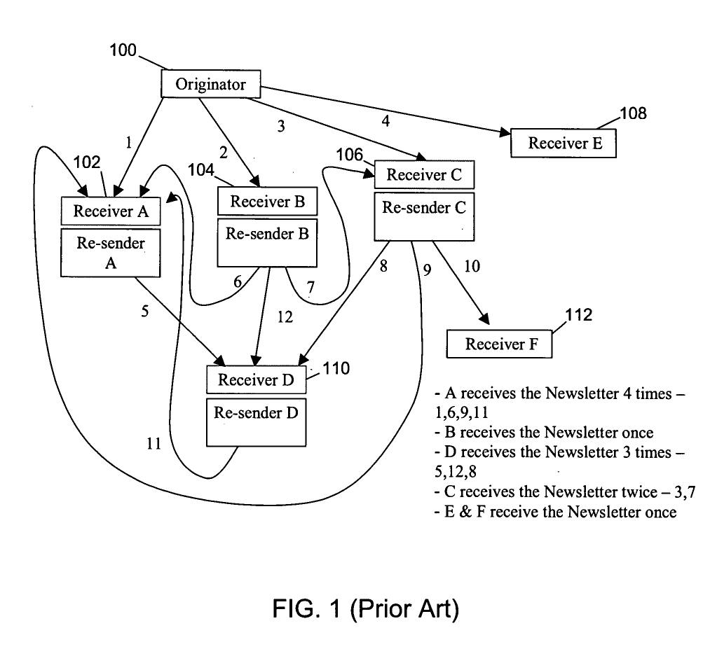

FIG. 1 is a diagram that illustrates the generation of multiple duplicate newsletter emails from a single originating sender to several direct and indirect recipients. An originating sender 100 sends an initial newsletter email communication directly to four intended recipients (receiver A, B, C, E—102, 104, 106, 108, respectively), as illustrated by path arrows 1, 2, 3, 4. Recipient A 102 resends the newsletter to recipient D 110 via path 5, as does recipient B 104 via path 12, and recipient C 106 via path 8. Therefore, recipient D 110 receives 3 duplicate copies of the newsletter, from three separate senders (102, 104, 106), who are each unaware that the other sender has forwarded the newsletter to recipient D 110. In a similar manner, recipient B 104 is unaware that recipient A 102 and recipient C 106 have already received the newsletter, and also forwards the newsletter to recipients A 102 and recipient C 106 via paths 6 and 7, respectively. In addition, recipient C 106 is unaware of recipient A 102 email, and forwards the newsletter email back to recipient A 102 via path 9, while also forwarding the newsletter to recipient F 112 via path 10. Furthermore, a recipient's email distribution list may also just automatically forward an email back to the recipient who actually sent the communication, as illustrated by recipient D 110 forwarding the newsletter back to recipient A 102 path 11.

Continuing with the example of FIG. 1, recipient A 102 receives the newsletter four times, while recipient D 110 receives the newsletter three times, and recipient C 106 receives the newsletter twice. The example of FIG. 1 illustrates the potential duplication of email communications that may occur in an enterprise. The duplicate emails not only tax an enterprise's email system, but also are a source of inefficient time usage by the recipients, who have to read or delete the multiple emails. Therefore, a means to avoid the duplication of email correspondence in an enterprise would be beneficial from both a hardware and personnel perspective.

Embodiments of the invention provide a method and system for the elimination of duplicate or multiple electronic communications to one or more recipients. In embodiments of the invention, an email communication is sent once to a mail server, and only once to a recipient's mailbox. In the event a server has already received the email, the email will not be sent again to the server. If the recipient has already received the email, the email server will not send the email to the recipient again. In embodiments of the invention, each individual mail server owns and manages a table that contains as many entries as the number of user mailboxes the mail server manages. Within a server, for each mailbox, the table contains information that enables the mail server to identify the email received by the involved parties.

Embodiments of the invention provide for the optimal delivery of bulk emails to a recipient's mailbox by maintaining a local history log (e.g., table containing a distribution/delivery list) of email delivery in the mail server of the recipient. The log contains a history of emails sent to every recipient mailbox under the delivery scope of the mail server, and the log is utilized to maintain only a single copy of every email being routed through the mail server to the recipients in a local repository within the mail server. In embodiments of the invention, the mail server upon receiving a request for delivering an email to any recipient under mail server's delivery scope, checks if the recipient has previously received the same or similar email by referring to the local history contained in the log. In embodiments of the invention, an email is delivered if the intended recipient has not received the email previously, either from the local repository (if a local copy is already hosted on the mail server), or forwarding the email to the intended recipient after creating a copy of the email in the local repository. In addition, embodiments of the invention may send the recipient an email link to the local repository holding the email, instead of the large bulky email itself, thereby conserving system resources.

Table 1 is an example of a table that identifies emails for preventing duplication according to embodiments of the invention. The table is populated for each recipient of an email as the recipient receives an email type for the first time. In the example presented in Table 1, the email has a specific template or email type identified as news information (NewsInfo). The NewsInfo template has an option called Forward_NewsInfo that enables the template to be forwarded to a distribution list. Users cannot modify the template in the email system. The Mail_ID parameter is unique and follows the NewsInfo email, even when the email is coupled with the Forward_NewsInfo command. The originator of the email (in the present example NewsInfo type) is flagged to avoid applying the same process mechanism to other email recipients. The table is reset periodically, where the periodicity is dependent on the context or the user requirements

TABLE 1

| TABLE NAME | USERS | PARAMETERS | COMMENTS |
|---|---|---|---|
| T_NEWSINFO | | | |
| | USER_ID_1 | | |
| | | MAIL_ID | Mandatory, must be |
| | | | always the same from |
| | | | the origin of the mail |
| | | ORIGINATOR_USER_ID | |
| | | DATE_SENT | |
| | | . . . | |
| | USER_ID_2 | | |
| | . . . | | |
| | USER_ID_n | | |

When a mail server receives emails that have user identifications of recipients under the mail server's environment, the mail server saves the emails in a dedicated repository, and enables the affected recipients with user identifications to access the emails. The server that receives the email may be the same as the server that issued the mail.

Embodiments of the invention are implemented with a server module that is running on a mail server. Continuing with the NewsInfo example, the server module upon receipt of a NewsInfo type email: updates the T_NEWSINFO table to mark the users that have received the email, stores the NewsInfo email in the NewsInfo mail repository, where the message is locally stored to have only one mail transfer in a target server; and sends the email to the target users under the server module's domain. In the event a user with a Forward_NewsInfo option forwards a NewsInfo email, the server module sends an advice message to the target servers to check if the target servers have already received the NewsInfo email. The server module receives and analyses ADVICE_RESPONSE messages (existing or not_existing parameters) that have been sent back by the target servers in response to the ADVICE message. If the target servers already have received the NewsInfo message, the NewsInfo message is not forwarded. If the target servers have not received the NewsInfo message, the NewInfo message is forwarded.

When a server module receives an ADVICE message, the server module checks in the NewsInfo mail repository to confirm the existence of the NewsInfo mail. In the event the NewsInfo mail is present, the server module returns an ADVICE_RESPONSE message with an “existing” notification, and the email is sent to the user identities (IDs) managed by the target server from the NewsInfo mail repository. In the event the NewsInfo mail is not present, the server module responds with an ADVICE_RESPONSE message with a “not_existing” notification.

Table 2 provides a list of ADVICE and ADVICE_RESPONSE messages. The USER_IDs are built from a distribution list of the Forward_NewsInfo command.

TABLE 2

| | |
|---|---|
| ADVICE | ADVICE_RESPONSE |
| SERVER_ORIGIN | SERVER_ORIGIN |
| SERVER_TARGET | SERVER_TARGET |
| MAIL_ID | existing or not_existing |
| ORIGINATOR_USER_ID | MAIL_ID |
| DATE_SENT | ORIGINATOR_USER_ID |
| Target USER_ID_1 | DATE_SENT |
| Target USER_ID_2 | Target USER_ID_1 |
| Target USER_ID_3 | Target USER_ID_2 |
| Target . . . | Target USER_ID_3 |
| | Target . . . |

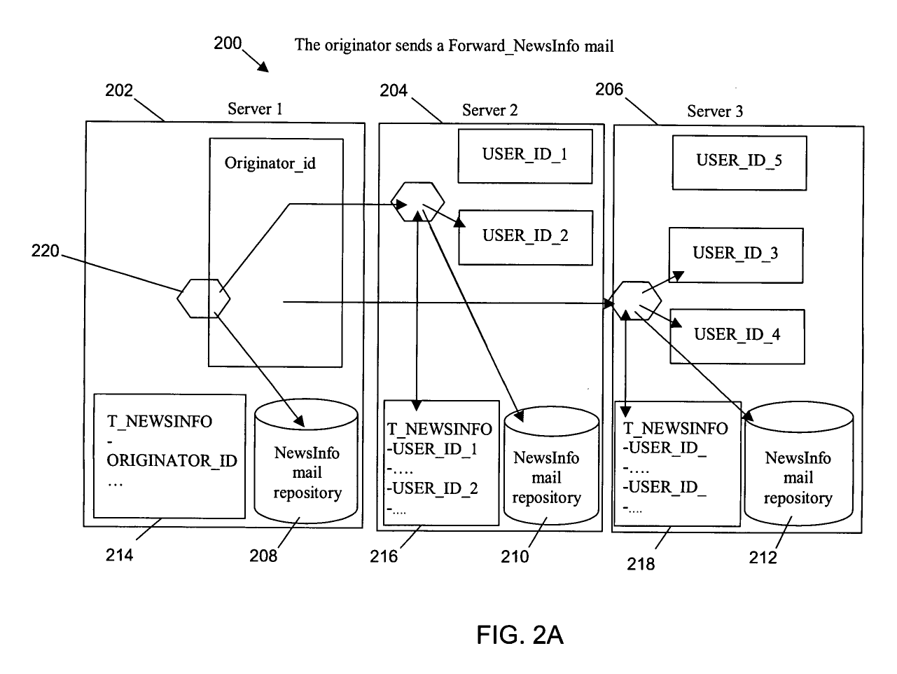

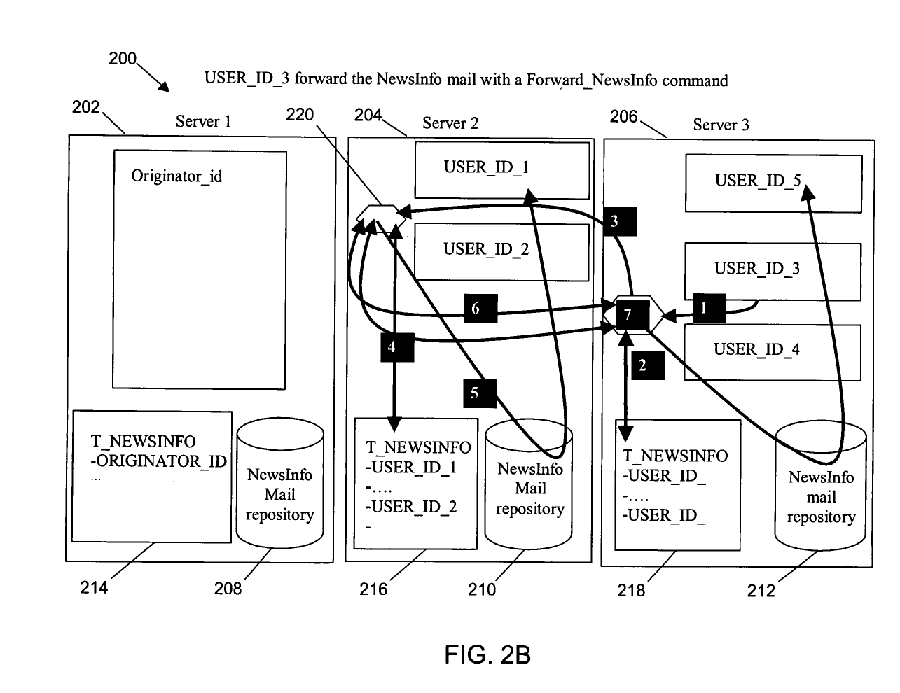

FIG. 2A is a functional block diagram illustrating the flow of a message in a system 200, where an originator sends a Forward_NewsInfo email to recipients located on different servers, according to embodiments of the invention. In the example, the originator (Originator_id) sends a NewsInfo email 220 from server 1 (202) to USER_ID_2 who is served by server 2 (204), and USER_ID_3 who is served by server 3 (206). The NewsInfo email 220 is stored into the mail repository of server 1 (202), and the T_NEWSINFO table 214 is updated in the server 1 to reflect that Originator_id has received the NewsInfo email 220. It is noted that the Originator_id is treated as a normal user id, but a specific name is used in the example of FIG. 2 to simplify the description.

Continuing with the example of FIG. 2A, server 2 (204) receives the NewsInfo email 220 for the first and unique time, and the T_NEWSINFO table 216 of server 2 (204) is updated with the MAIL_ID, the ORIGINATOR_USER_ID, and DATE_SENT as seen in Table 1. In addition the NewsInfo email 220 is stored in the NewsInfo mail repository 210. In a similar manner the NewsInfo email is sent to USER_ID_3 and USER_ID_4 who are served by server 3 (206), the T_NEWSINFO table 218 of server 3 (206) is updated, and the NewsInfo email 220 is stored in the NewsInfo mail repository 212 of server 3 (206).

FIG. 2B is a functional block diagram of the system 200 of FIG. 2A where (1) USER_ID_3 served by server 3 (206) forwards the NewsInfo email 220 using the Forward_NewsInfo command to USER_ID_5 and USER_ID_4 served by server 3 (208) and to USER_ID_1 and to USER_ID_2 served by server 2 (204). (2) Server 3 (206) checks in the T_NESWSINFO local table 218 if USER_ID_4 has already received the NewsInfo email 220. Since the answer is yes, and USER_ID_4 has already received the NewsInfo email 220, no action is taken and the NewsInfo email 220 is not forwarded to USER_ID_4. Server 3 also determines if USER_ID_5 has already received the NewsInfo email 220, by checking in the T_NESWSINFO local table 218 if USER_ID_5 has indeed received the NewsInfo email 220. In the present example the answer is no, and the NewsInfo email 220 is retrieved from the repository and sent to USER_ID_5.

Continuing with the example of FIG. 2B, (3) two ADVICE messages are sent from server 3 (206) to server 2 (204) (one for each target user) with the following parameters:
a. Server 2, Server 3, MAIL_ID, ORIGINATOR_USER_ID, DATE_SENT, USER_ID_1.
b. Server 2, Server 3, MAIL_ID, ORIGINATOR_USER_ID, DATE_SENT, USER_ID_1.

Server 2 (204) checks (4) the T_NESWSINFO table 216 to determine if USER_ID_1 has already received the NewsInfo email 220. In the present example the answer is no, and server 2 (204) subsequently determines if the NewsInfo email 220 exists in the mail repository 210. In the present example the NewsInfo email 220 does exist in the mail repository 210, and as a result server 2 (204) sends an ADVICE_RESPONSE message back to server 3 (206) with the following parameters:
a. Server 2, Server 3, “existing”, MAIL_ID, ORIGINATOR_USER_ID, DATE_SENT, USER_ID_1.
   Subsequently (5), server 2 (204) retrieves the NewsInfo email 220 from the mail repository 210 and is sent to USER_ID_1.

Next (6), server 2 (204) checks in the T_NESWSINFO table 216 if USER_ID_2 has already received the NewsInfo email 220 message. In the present example the answer is yes, and as a result server 2 (204) sends an ADVICE_RESPONSE message back to server 3 (206) with the following parameters:
a. Server 2, Server 3, “existing”, MAIL_ID, ORIGINATOR_USER_ID, DATE_SENT, USER_ID_1.
   In response to the receipt of the ADVICE_RESPONSE message, server 3 (206) checks the “existing” or “not_existing” parameter. In the present example, the response is “existing”. Therefore, the NewsInfo email 220 is not sent to USER_ID_2, and no further action is taken.

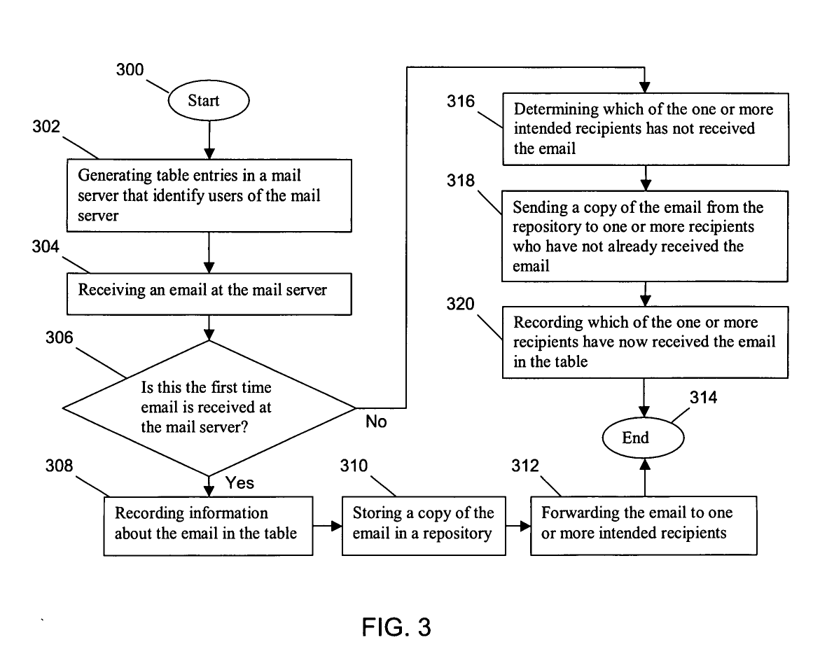

FIG. 3 illustrates a flow chart illustrating a method for the elimination of duplicate or multiple electronic communications to one or more recipients, according to an embodiment of the invention. The process starts (block 300) with the generation of entries in a table in a mail server that identify users of the mail server (block 302). Receiving an email at the mail server (block 304), and determining if this is the first time the email has been sent to the mail server (decision block 306), wherein in the event this is the first time the email has been received at the mail server (decision block 306 is Yes), recording information about the email in the table (block 308), and storing a copy of the email in a repository (block 310), and forwarding the email to one or more intended recipients (block 312). In the event the mail server has already received the email previously (decision block 306 is No), determining which of the one or more intended recipients has not received the email (block 316), sending a copy of the email from the repository to one or more recipients who have not already received the email (block 318), and recording which of the one or more recipients have now received the email in the table (block 320), and the process ends (block 314)

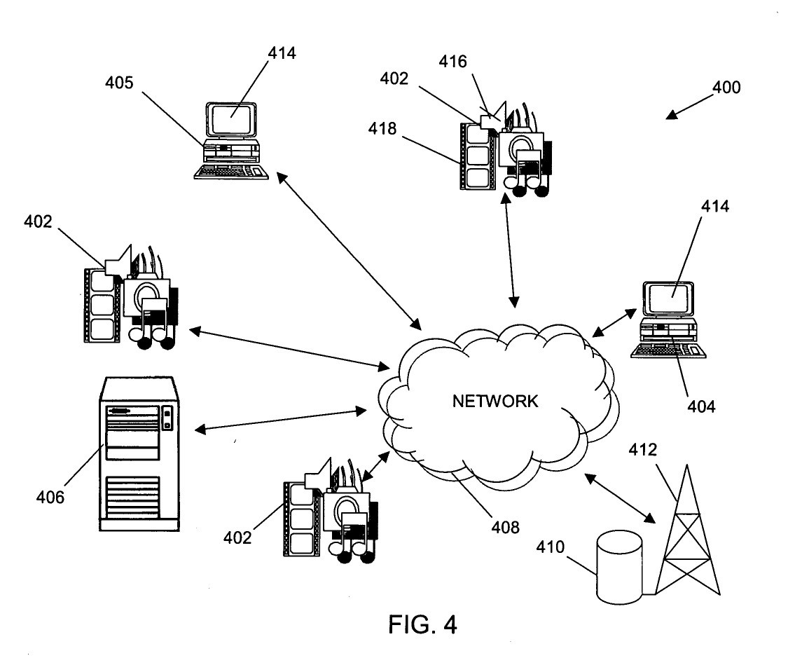

FIG. 4 is a block diagram of an exemplary system 400 for the elimination of duplicate or multiple electronic communications to one or more recipients according to embodiments of the invention, and graphically illustrates how these blocks interact in operation. The system 400 includes remote devices including one or more multimedia/communication devices 402 equipped with speakers 416 for implementing the audio, as well as display capabilities 418 for facilitating graphical user interface (GUI) aspects of the present invention. In addition, mobile computing devices 404 and desktop computing devices 405 equipped with displays 414 for use with the GUI of the present invention are also illustrated. The remote devices 402 and 404 may be wirelessly connected to a network 408. The network 408 may be any type of known network including a local area network (LAN), wide area network (WAN), global network (e.g., Internet), intranet, etc. with data/Internet capabilities as represented by server 406. Communication aspects of the network are represented by cellular base station 410 and antenna 412. Each remote device 402 and 404 may be implemented using a general-purpose computer executing a computer program for carrying out the GUI described herein. The computer program may be resident on a storage medium local to the remote devices 402 and 404, or maybe stored on the server system 406 or cellular base station 410. The server system 406 may belong to a public service. The remote devices 402 and 404, and desktop device 405 may be coupled to the server system 406 through multiple networks (e.g., intranet and Internet) so that not all remote devices 402, 404, and desktop device 405 are coupled to the server system 406 via the same network. The remote devices 402, 404, desktop device 405, and the server system 406 may be connected to the network 408 in a wireless fashion, and network 408 may be a wireless network. In a preferred embodiment, the network 408 is a LAN and each remote device 402, 404 and desktop device 405 executes a user interface application (e.g., web browser) to contact the server system 306 through the network 308. Alternatively, the remote devices 402 and 404 may be implemented using a device programmed primarily for accessing network 408 such as a remote client.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for the elimination of duplicate or multiple electronic mail (email) communications to one or more recipients, wherein the method comprises:
generating table entries in a mail server that identify users of the mail server;
receiving an email at the mail server;
determining whether the receiving an email at the mail server represents the first time the email is received at the mail server, based on prior entries in the table generated for previous received emails;
wherein, in the event it is determined that it is the first time the email has been received by the mail server:
recording information about the email in the table;
storing a copy of the email in a repository;
forwarding the email to one or more intended recipients that are among the identified users of the mail server; and
wherein in the event the email has been received previously by the mail server:
determining which of the one or more intended recipients has not received the email, based on prior entries in the table generated for previous received emails;
sending a copy of the email from the repository to one or more recipients who have not already received the email; and
recording which of the one or more recipients have now received the email in the table.

2. The method of claim 1, wherein the one or more recipients are sent an email link to the local repository holding the email, instead of the email itself.
